(19) United States
(12) Patent Application Publication
(10) Pub. No.: US 2001/0034648 A1
(43) Pub. Date: Oct. 25, 2001

(54) Method and apparatus for obtaining remote photographs or video using unilateral contract applications

(76) Inventor: Kenneth Nelson Caldwell, Incline Village, NV (US)

Correspondence Address: Kenneth N. Caldwell, 785 Southwood Blvd., Ste. 3, Incline Village, NV, 89451, US

(21) Appl. No.: 09/776,448

(22) Filed: Feb. 5, 2001

Related U.S. Application Data
(60) Provisional application No. 60/180,496, filed on Feb. 5, 2000.

(51) Int. Cl. G06F 17/60

(52) U.S. Cl. 705/14

(57) ABSTRACT

An internet based method that allows a person to obtain a photograph from a remote location quickly and at a reasonable cost. The method promotes speed in that it is based on unilateral contract principles such that only the first photographer who accurately responds to a photograph seeker's request receives a promised incentive. A reasonable cost is obtained by letting the photographer seeker name their own price for the photograph. In this way, only photographers in closest proximity to the target location are likely to respond, which in essence gives the photography assignment to the lowest cost and most efficient photographer.

### CROSS REFERENCE TO RELATED APPLICATION

This application claims the benefit of U.S. Provisional Application Ser. No. 60/180,496, filed Feb. 5, 2000.

### BACKGROUND AND SUMMARY OF THE INVENTION

This invention involves the use of unilateral contract applications as a method to obtain remote photographs or video using electronic networks.

There has never been a particularly practical and cost efficient method of obtaining a time sensitive photograph from a remote location. A person could hire a professional photographer to take a picture and provide a photograph, but generally by the time a photographer was located, the request was described, an agreement reached, the picture taken, the services paid for, and the photograph delivered, a significant amount of time would have elapsed. More importantly the cost to obtain a single photograph using such a method would often be cost prohibitive.

The present invention overcomes the impracticality and expense constraints of obtaining a time sensitive photograph of places or property in a remote location. It allows a person the opportunity of sitting at home or office in front of a personal computer and obtaining a time sensitive photograph of a place or particular item of property virtually anywhere in the world within a very short time frame at a very reasonable cost. The present invention will open up entirely new and untapped markets for photographs because of the ease and low cost of obtaining time sensitive photographs anywhere in the world. Business and individuals may use it to keep track of various property interests; check on people or places, view places they intend to travel before they go, or visit places they have never been. Vehicle occupants could use it to check on traffic or weather conditions in a different location. Numerous other practical uses exist for the present invention.

Although there is no known prior art that would cover or contemplate this method and apparatus for obtaining remote photographs or video, it utilizes unilateral contract principles described in patent application Ser. No. 09,352,490 filed Jul. 13, 1999, by Inventor: Kenneth N. Caldwell.

A system premised on unilateral contract law allows a photographer to bind the photograph seeker to a contract in one easy step by providing the photograph requested. Using an intermediary to collect funds and control their distribution gives the photographer assurance that he will be able to collect the promised monetary incentive. The fact that a photographer can only bind the photograph seeker to a contract by providing the requested photograph, as opposed to promising to provide the requested photograph, is the attribute of this invention that accelerates the response process and allows a photograph seeker a way to quickly receive a remote photograph at a reasonable cost that is not existent in the prior art.

Unlike the prior art, the present invention facilitates the transfer of remote photographs from photographers to photograph seekers.

### BRIEF DESCRIPTION OF THE DRAWINGS

FIG. 1 illustrates a first embodiment of the present invention;

FIG. 2 is a block diagram showing one embodiment of the central controller;

FIG. 3 is a block diagram showing one embodiment of the photograph seeker/photographer interface;

FIG. 4 illustrates an embodiment showing how a conditional photograph request is generated;

FIG. 5 illustrates an embodiment showing credit card approval through the central controller and transfer of funds to the intermediary host from the photograph seeker;

FIG. 6 illustrates an embodiment showing the activation of a conditional photograph request;

FIG. 7 illustrates one embodiment of the maintenance of active conditional photograph requests;

FIG. 8 illustrates an embodiment showing a photographer accessing a conditional photograph request;

FIGS. 9 and 10 illustrate an embodiment showing the consummation of a unilateral contract that occurs when a photograph is provided by a photographer.

### Reference Numerals in the Drawings

100 Conditional Photograph Request (“CPR”)

110 Photograph

200 Central Controller

205 CPU

210 Random Access Memory (RAM)

215 Read Only Memory (ROM)

200 Payment Processor

225 Clock

230 Operating System

235 Network Interface

240 Data Storage Device

245 Registered User Database

250 Photograph Request Database

255 Photographer Response Database

260 Contract Detail Database

265 Payment Database

270 Audit Database

300 User Interface

350 Modem

### DETAILED DESCRIPTION OF THE DRAWINGS

The method and apparatus of the present invention will now be discussed. In a preferred embodiment the present invention includes central controller 200, photograph seeker/photographer interface 300 and associated databases. The present invention receives conditional photograph requests from the photograph seeker, makes them available for viewing by photographers in the form of an offer to enter into a unilateral contract and allows photographers to submit a photograph thereby completing a unilateral contract with the photograph seeker, provided the conditions imposed by the photograph seeker are met. The system is operated by an intermediary host/central controller who collects the payment or other incentive offered from the photograph seeker in advance, giving the photographer assurance that he/she will receive the payment or other incentive offered by the photograph seeker for providing a photograph responsive to the request.

### System Architecture

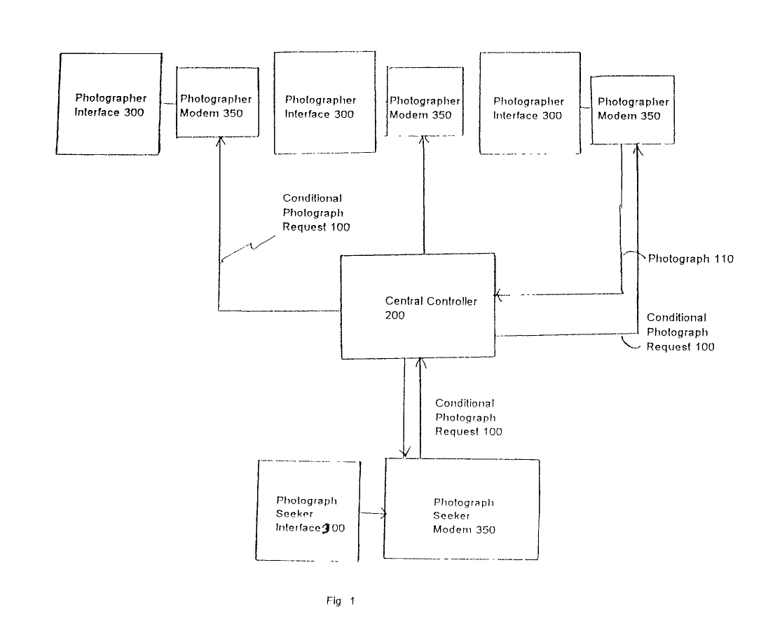

The system architecture of a first embodiment of the apparatus and method of the present invention is illustrated with reference to FIGS. 1 through 3. As shown in FIG. 1, the apparatus of the present invention comprises photograph seeker/photographer interface 300, and central controller 200 (collectively the “nodes”). Each node is connected via an Internet connection of some type. Using the above components, the present invention provides a method and apparatus for photograph seekers to list conditional photograph requests, make them available to photographers and allow them to ripen into completed unilateral contracts when a photographer provides a photograph that meets the conditions of the photograph request.

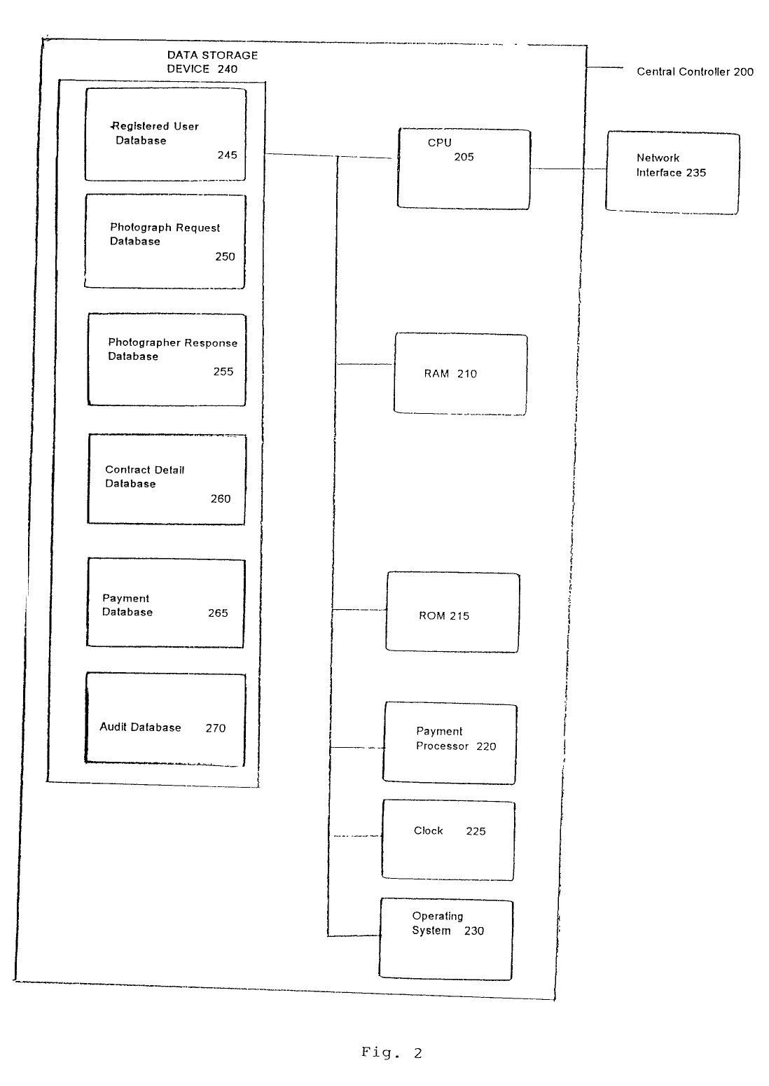

As shown in FIG. 2, central controller 200 includes central processor (CPU) 205, RAM 210, ROM 215, payment processor 220, clock 225, operating system 230, network interface 235, and data storage device 240. A conventional personal computer or computer workstation with sufficient memory and processing capability may be used as central controller 200. In one embodiment it operates as a web server, both receiving and transmitting conditional photograph requests 100 generated by photograph seekers. Central controller 200 must be capable of high volume transaction processing, performing a significant number of mathematical calculations in processing, communications and database searches. A Pentium microprocessor commonly manufactured by Intel Inc., may be used for CPU 205.

Referring again to FIG. 2, payment processor 220 comprises one or more conventional microprocessors (such as the Intel Pentium), supporting the transfer and exchange of payments, charges, or debits, attendant to the method of the apparatus. Payment processor 220 may also be configured as part of CPU 205. Processing of credit card transactions by payment processor 220 may be supported with commercially available software. Data storage device 240 contains databases used in the processing of transactions in the present invention, including user database 245, photograph request database 250, photographer response database 255, contract detail database 260, payment database 265, and audit database 270. In a preferred embodiment, database software is used to create and manage these databases.

Registered user database 245 maintains data with fields such as name, address, credit card number(s), telephone number, facsimile number, beeper number, pager number, other contact information, identification number, social security number, electronic mail address, etc. Most of this information is input into the user database when the user first registers with the system.

Conditional photograph request database 250 tracks all conditional photograph requests 100 with fields such as photograph seeker's user identification number, contract conditions and details, status of request, tracking number, posting date, posting time, location, listing price, and expiration date and time.

Photographer response database 255 maintains data with fields such as tracking number, respondent's identification number, date of response, time of response, and the size of the file received in response.

Contract detail database 260 contains form contract provisions for inclusion in conditional photograph request 100. These standard contract provisions can be triggered by the photograph seeker by various means and become incorporated into the offer to enter into the unilateral contract with the photographer.

Payment database 265 tracks all payments made by the users to the intermediary host/central controller with fields such as user's name, user's identification number, amount of payment or credit, date of payment, and tracking number(s), etc.

Audit database 270 stores transactional information relating to the posting of conditional photograph requests 100 allowing the data to be retrieved for later analysis.

Network interface 235 is the gateway to communicate with photograph seekers and photographers through interface 300. Conventional internal or external modems may serve as network interface 235. Network interface 235 supports modems at a range of baud rates from 1200 upward, but may combine such inputs into a T1 or T3 line or other device if more bandwidth is required. In a preferred embodiment, network interface 235 is connected with the Internet and/or any of the commercial on-line services such as America Online or CompuServe allowing photograph seekers and photographers access from a wide range of on-line connections. Several commercial electronic mail servers include the above functionality. The system may also support multiple languages. Alternatively, network interface 235 may be configured as a voice, website, BBS, pager, or electronic mail address interface.

While the above embodiment describes a single computer acting as central controller 200 those skilled in the art will realize that the functionality can be distributed over a plurality of computers. In one embodiment, central controller 200 is configured in a distributed architecture, wherein the databases and processors are housed in separate units or locations. Some controllers perform the primary processing functions and contain at a minimum RAM, ROM, and a general processor. Each of these controllers is attached to a hub which serves as the primary communication link with the other controllers and interface devices. The hub may have minimal processing capability itself, serving primarily as a communications router. An almost unlimited number of controllers may be supported. This arrangement yields a more dynamic and flexible system less prone to hardware failures affecting the entire system.

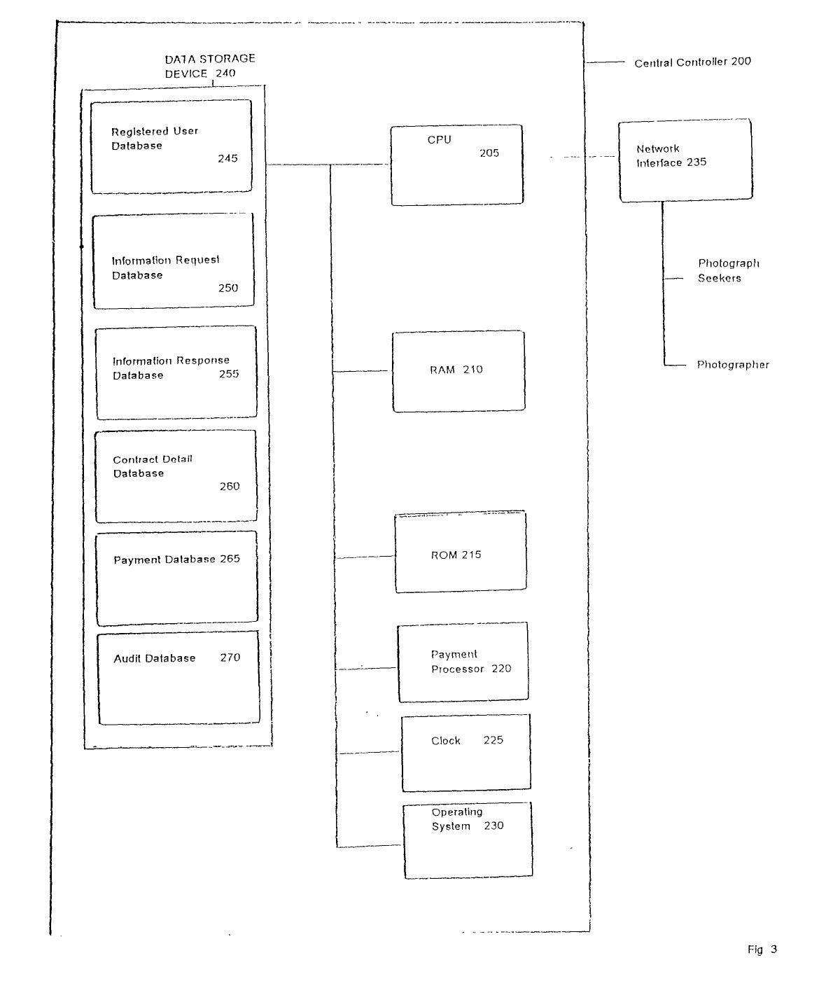

FIG. 3 describes user interface 300 which is suitable for both the photograph seeker and the photographer. In one embodiment it utilizes a conventional personal computer having an input device, such as a keyboard, mouse, or conventional voice recognition software package; a display device, such as a video monitor, a processing device such as a CPU; and a network interface such as a modem. These devices interface with central controller 200. Alternatively, the photographer interface 300 may also be voice mail systems, or other electronic or voice communications systems. As will be described further in the following embodiments, devices such as fax machines or pagers are also suitable interface devices.

There are many commercial software applications that can enable the communications required by user interface, the primary functionality being message creation and file transmission. Eudora Pro manufactured by Qualcomm Incorporated, for example, provides editing tools for the creation of messages as well as the communications tools to route the message and photograph file to the appropriate electronic address.

When central controller 200 is configured as a web server, conventional communications software such as the Netscape Navigator web browser from Netscape Corporation may also be used. The photograph seeker and photographer may use the Netscape Navigator browser to transmit conditional photograph requests 100, and photographs 110, respectively. No proprietary software is required.

### Online Embodiment

In one embodiment of the present invention, communications between the photograph seeker and the photographer take place via electronic networks, with central controller 200 acting as a web server. The photograph seeker logs on to central controller 200, creates a conditional photograph request 100, pays the intermediary host with a credit card or from an existing account balance, and then disconnects from the network. Conditional photograph request 100 is made available to photographers by listing the conditional photograph request 100 on the central controller, specifically on the central controller intermediary host's web page. Periodic maintenance is performed by central controller 200 to ensure that active conditional photograph requests have not expired. Photographs 110 are transmitted electronically to central controller 200 which routs the photograph in digital form to the photograph seeker by email, or other device.

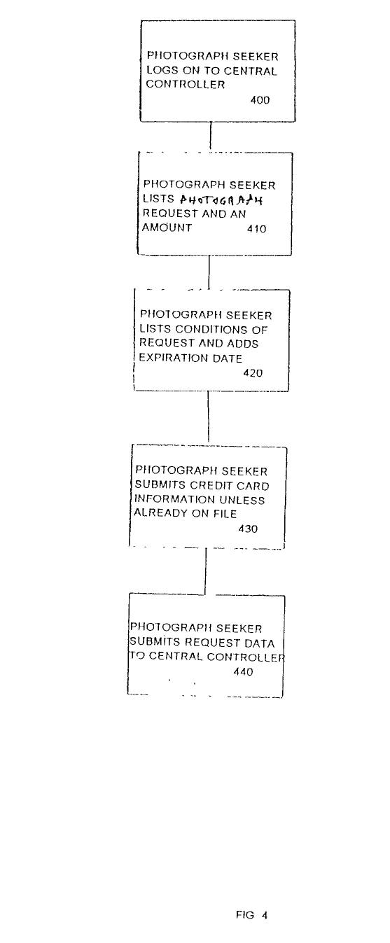

With reference to FIG. 4, there is described the process by which the photograph seeker formulates a conditional photograph request 100. At step 400, the photograph seeker logs on to central controller 200 using modem 350, establishing a communication link.

In one embodiment central controller 200 has a page on the world wide web, allowing the photograph seeker to provide a conditional photograph request through the interface of conventional web browser software such as Netscape Navigator manufactured by Netscape, Inc. At step 410, the photograph seeker enters the location of the photograph requested and an amount of money that he is willing to pay for a photograph responsive to the request. The photograph seeker then adds other conditions of the request including an expiration date at step 420. The conditions could also indicate that secondary photographs are also being accepted as a backup to the original photograph, in the event there is a problem with or objection to the first photograph received, or to be accepted under otherwise specified conditions. The expiration date allows a photograph seeker to list a conditional photograph request 100 without worrying that he will later be bound after his needs have changed. At step 430, the photograph seeker enters credit card or other payment information to make payment, unless the credit card or other payment information is already on file.

At step 440 the photograph seeker submits the request and central controller processes it and displays the request on a web site and/or transmits the request by various means. The photograph seeker does this by clicking on a “send” or “submit” button located on the screen in which he entered the terms of the conditional photograph request 100.

Instead of a world wide web-based interface, the photograph seeker may also transmit his/her conditional photograph request 100 to the central controller via electronic mail, or voice mail transmission. With voice mail the photograph seeker calls central controller 200 and leaves the conditional photograph request 100 in audio form. These conditional photograph requests 100 may be transcribed into digital text at central controller 200, or made available to potential photographers in the same audio format.

Central controller 200 supports a plurality of transmission methods, allowing for a wide variety of formats of conditional photograph requests 100. Some formats may be changed however, before further processing by central controller 200.

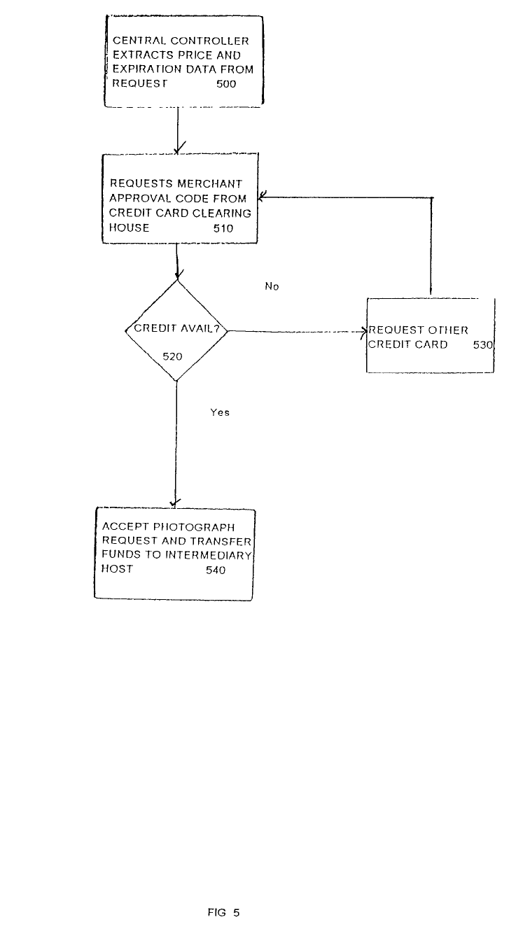

Referring now to FIG. 5, at step 500 central controller extracts listing price and expiration data from the information request. At step 510, payment processor 220 submits a request for authorization and transfer of the listing price of the conditional photograph request 100 and any related fees to the credit card clearinghouse and/or checks the users account balance.

At step 520, the credit card clearinghouse responds to the authorization, indicating whether sufficient credit is available, and if so acknowledging the transaction and transferring funds at step 540. If sufficient funds are not available, another credit card number is requested from the photograph seeker at step 530. Once an additional credit card number has been transmitted, central controller 200 then resubmits the authorization at step 510.

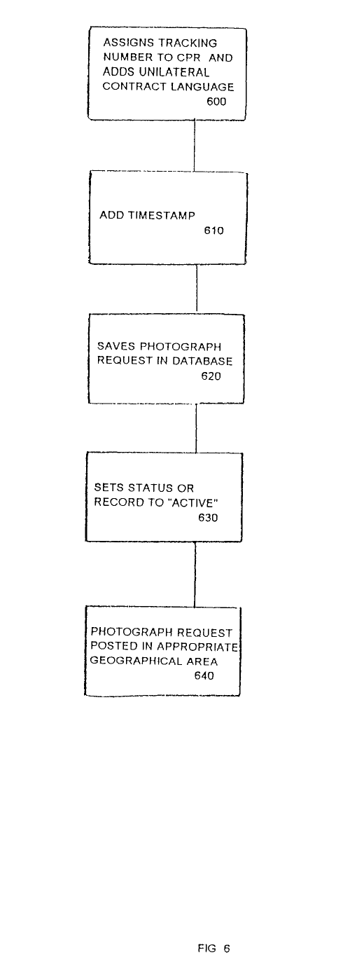

Referring now to FIG. 6, there is illustrated an embodiment in which the conditional photograph request 100 is activated and made available to interested photographers. At step 600, a unique tracking number may be added to the conditional photograph request 100. In addition, legal contract terminology may be added to the conditional photograph request 100 to form a complete offer to enter into a unilateral contract. The legal contract terminology may be pulled from contract detail database 260 which stores a plurality of contract provisions. These provisions may be linked together to form a complete conditional photograph request 100.

Central controller timestamps the conditional photograph request, at step 610, and then stores conditional photograph request in database 250. Conditional photograph request database 250 contains a record for each conditional photograph request and includes fields such as photograph seeker's user identification number, contract details and conditions, status of request, tracking number, posting date, posting time, subject, listing price, and expiration date. The status field may contain values such as “active,” “pending,” “completed,” or “expired.”

A status of “active” means a conditional photograph request 100 is available to photographers as a unilateral contract offer and can be converted to a completed unilateral contract with the receipt of an appropriate photograph. A status of “pending” means that the conditional photograph request is not currently available to interested photographers because it is either being processed by central controller 200, or it has been temporarily suspended by the photograph seeker. An “expired” conditional photograph request can no longer be acted upon. Conditional photograph requests which have been satisfied have their status changed to “completed” and/or are eventually removed from the web site.

After being stored at step 620, a conditional photograph request 100 may go through a series of processing steps. One step, if necessary, is language translation, either creating a standard language that all conditional photograph requests 100 must be written in, or translating to the language most appropriate for the photographers to which it will be sent. This translation is provided by language experts at central controller 200, or by automatic translation software. Another step, if necessary, is to edit for spelling or grammatical errors. Conditional photograph request 100 might also be reviewed for clarity. Any conditional photograph request 100 with an unclear term or condition could be returned to the photograph seeker for clarification.

Referring again to FIG. 6, the status of the database record for the conditional photograph request 100 is set to “active” at step 630. At step 640, the conditional photograph request is posted in an appropriate area of the web site organized by geographical area. This allows central controller 200 to display or direct the conditional photograph request 100 to the most appropriate photographers. In a world wide web environment, central controller 200 may have a web page or section for each city, county or other geographical subdivision. This makes it much easier for photographers to find appropriate conditional photograph requests 100 in their close physical proximity. In an alternative embodiment, the conditional photograph request 100 is electronically mailed to photographers either individually or in groups. Photographers could elect to receive conditional photograph requests that meet certain specified criteria.

In an embodiment in which conditional photograph requests 100 are being transmitted to the photographers, it is important to note that there are a number of hardware options for photographer interface 300. Suitable photographer interfaces 300 include fax machines, wireless phones or other connections, and beepers or pagers.

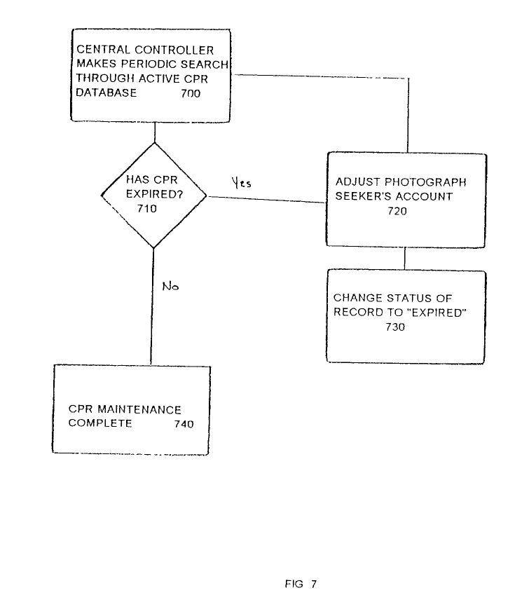

Referring now to FIG. 7, there is illustrated a procedure for the maintenance of conditional photograph requests 100. At step 700 central controller 200 searches the conditional photograph request database 250. At step 710 the expiration date field of each conditional photograph request database record is compared to the current date. If the expiration date of the conditional photograph request is earlier than the current date the status of conditional photograph request 100 is changed to “expired” at step 720, and the photograph seekers' account adjusted as step 730. The maintenance process is completed at step 740 once all active conditional photograph request 100 database records have been examined.

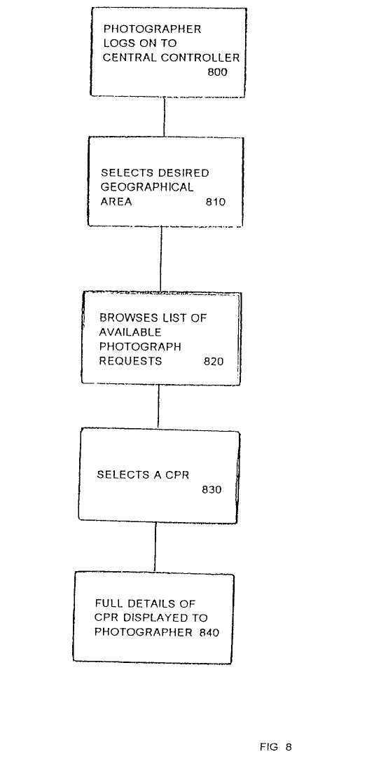

FIG. 8 illustrates one process by which a photographer selects a conditional photograph request. At step 800, the photographer logs onto the central controller 200 using modem 350 of photographer interface 300. At step 810, the photographer selects the desired geographical location. At step 820, the photographer browses the list of available conditional photograph requests 100 (i.e. those with a status of “active”). Conditional photograph requests 100 may be listed with minimal details, with additional information available only if the photographer is interested in reviewing the full terms of the conditional photograph request 100. A photographer who desires more information about a conditional photograph request 100 may request additional data at steps 830 and 840.

In one embodiment, each conditional photograph request is hyperlinked to a separate web page which provides complete details. The photographer clicks on the conditional photograph request and is immediately transferred to the page of supporting detail. See step 840.

In another embodiment, the conditional photograph request 100 is electronically transmitted directly to the photographer via electronic mail, fax, cell phone, beeper, other wireless device, etc.

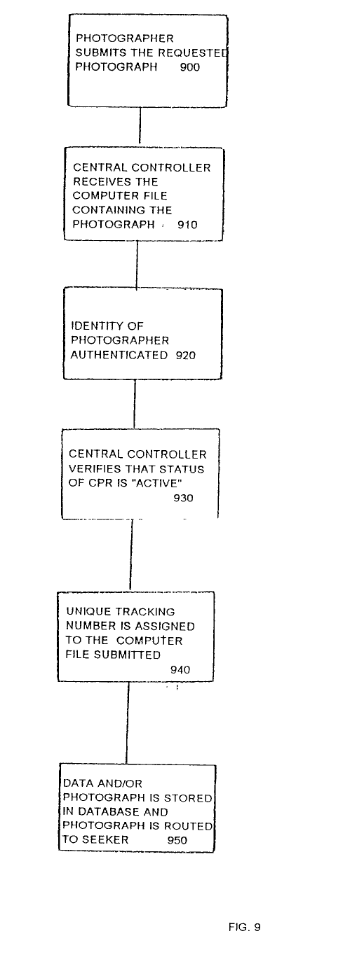

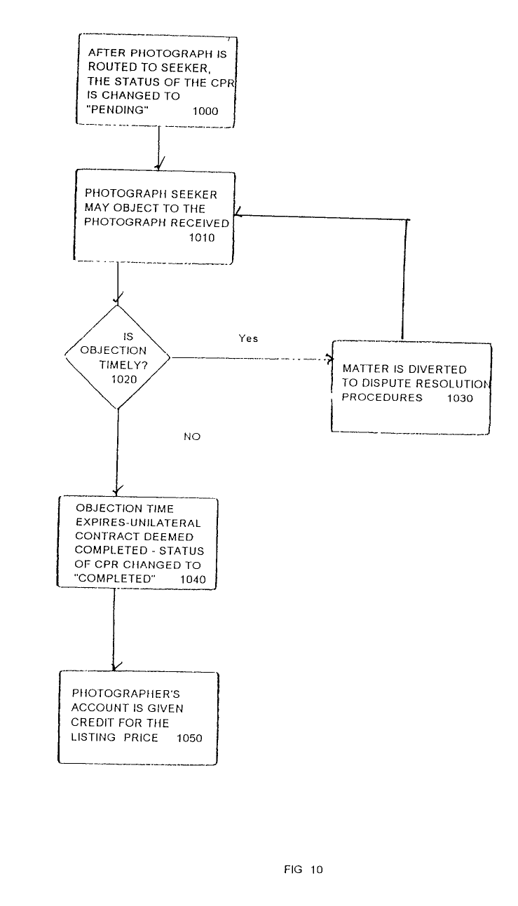

FIGS. 9 and 10 illustrate the process by which a unilateral contract is completed by virtue of the photographer submitting a computer file that will display the requested photograph in response to the conditional photograph request. After the photographer has selected a conditional photograph request which he would like to respond to and receive any payment or incentive offered, he takes the requested photograph, if necessary, converts it to a computer file that can be transferred via computer, and submits the photograph at Step 900. At step 910, central controller 200 receives the computer file sent in response to a conditional photograph request. Central controller 200 then timestamps the photographer's response, makes a record of the size of and/or saves the file 110 and authenticates the identity of the photographer at step 920. The timestamp allows central controller 200 to determine the first computer file/photograph to be received. Authentication of the photographer's identity involves central controller 200 extracting the photographer's identification from the photographer's response 110 and looking up the photographer's identity in user database 245.

Central controller 200 then verifies the status of the conditional photograph request 100 at step 930 determining whether or not the status of the conditional photograph request 100 is “active.” If the conditional photograph request 100 is currently “active,” a unique tracking number is assigned to photograph's response 110 at step 940. Central controller 200 then stores a record of the photographer's computer file and related data at step 950. If the status of the conditional photograph request 100 is not “active” at step 940, a message is transmitted back to the submitting photographer.

In FIG. 10, at step 1000, the unilateral contract is completed with the receipt of a computer file that contains the requested photograph that meets the conditions of the offer, turning the conditional photograph request into a legally completed unilateral contract between the photograph seeker and photographer. Also at step 1000 the status of the confidential photograph request is changed to “pending” or “completed,” preventing other photographers from attempting to accept the unilateral offer specified in the conditional photograph request 100. In one embodiment at step 1010 the photograph seeker has a specified length of time to object to the response thus diverting the transaction to the dispute resolution procedures. At step 1020, an objection is received and checked to determine if it is timely. If it is timely, the matter is diverted to the dispute resolution procedures. At step 1040, the time for objection having ended, the unilateral contract is deemed “completed” and a confirmation is transmitted to the photograph seeker and photographer. The status of the conditional photograph request is then changed to “completed.” At step 1050, the photographer's account is credited with the photograph seeker's listing price.

In another embodiment, multiple photographers may each form unilateral contracts with the photograph seeker. In that case the conditional photograph request may maintain its status of “active” until a given number of photographers have sent photographs, and only then is the status of the conditional photograph request changed to “pending” or “completed.” A condition of the conditional photograph request 100 may state that the offer is open to the first several photographers to respond allowing the completion of multiple unilateral contracts. Another option is to open the conditional photograph request 100 to any number of responses up to the funds made available by the photograph seeker.

There are many methods by which the photographers could derive a revenue stream. In the preferred embodiment, a monetary amount selected by the photograph seeker is paid to the intermediary host, and subsequently to the photographer after successful completion of the unilateral contract. There could also be fees and payments that would cover any number of conditional photograph requests.

In another embodiment, central controller 200 calculates a discounted value of the price in which photographers receive only a percentage of the price or incentive offered by the photograph seeker. In another embodiment, points are assigned to various photographs provided and the photograph with the highest number of points is selected as the compensable response. In another embodiment, advertisers pay to have messages listed along with the conditional photograph request 100, supplementing the costs of operating the system. Alternatively, the method and apparatus of the present invention may be employed without a payment or other incentive to a photographer. In a further alternative, photographers may be offered non-monetary incentives such as points or prizes for meeting the conditions of the photograph seeker's request.

### Payment Preferences

Preferred methods of payment include credit cards, personal checks, electronic funds transfer, digital money, etc. The photograph seeker transmits payment data corresponding to his preferred method of payment to central controller 200. These payment methods are meant to be merely illustrative, however, as there are many equivalent payment methods commonly known in the art which may also be used. If the photograph seeker wants to pay by credit card for example, payment data would include his credit card account number, expiration date, and amount of transaction which will include the fees charged by the intermediary host. For electronic funds transfer, payment data includes the name of the photograph seeker's bank and his account number. Central controller 200 stores payment data and payment preferences in payment database 265.

Another method of payment involves procedures using digital cash. Central controller 200 looks up the photograph seekers' electronic delivery address in payment database 265. This address is transmitted to payment processor 220 with the digital cash being downloaded from the photograph seeker. The digital cash is downloaded to the intermediary host's account. Central controller 200 then updates payment database 265 to indicate that payment has been made. The practice of using digital cash protocols to effect payment is well known in the art and need not be described here in detail. For reference, one of ordinary skill in the art may refer to Daniel C. Lynch and Leslie Lundquist, Digital Money, John Wiley & Sons, 1996; or Seth Godin, Presenting Digital Cash, Sams Net Publishing, 1995.

### Additional Authorization Embodiment

In another embodiment, the photograph seeker may transmit a digitally signed release message to central controller 200, authorizing the release of funds by the intermediary host to the photographer.

### Off-line Embodiment

In one embodiment of the present invention, photograph seekers and photographers communicate in an off-line manner with central controller 200. Rather than sending electronic mail or using, web-based servers, photograph seekers and photographers use a telephone, fax machine, or other off-line communication device. A photograph seeker may use a telephone, for example, to generate a conditional photograph request 100. The photograph seeker calls central controller 200 and is connected with an agent. The photograph seeker provides the terms of the conditional photograph request 100. The photograph seeker also provides his user identification, password, or private key so that central controller 200 can authenticate his identity. The agent puts this data into digital form by typing it into a terminal. The conditional photograph request 100 is then transmitted to central controller 200 where it is made available to photographers as described in the on-line embodiment.

In an alternative embodiment, the photograph seeker calls central controller 200 and is connected with a conventional Interactive Voice Response Unit (IVRU) which allows the photograph seeker to enter some or all of the terms of conditional photograph request 100 without the assistance of a live agent. Photographers may also use a telephone to browse the conditional photograph requests 100. The photographer calls central controller 200 and selects a location. Central controller 200 then converts the text of each conditional photograph request 100 into audio form, transmitting the audio list to the photographer. Photograph seekers may also communicate with an agent at central controller 200 through faxes or other device.

### Anonymous Transactions Embodiment

As mentioned previously, the present invention can provide for the anonymity of both photograph seekers and photographers. Such anonymity is accomplished by eliminating any recognizable identifier for the transactions. A photograph seeker for example, would include his identification number in the conditional photograph request rather than his name, preventing the photographer from discovering the photograph seeker's identity.

### Dispute Resolution Protocols

Although the previous embodiments have generally described the conveyance of computer files containing photographs from photographer to photograph seeker as the end of the transaction, there will inevitably be disputes arising from some transactions, requiring follow-up activity to resolve these disputes. The present invention can support dispute resolution in several ways.

First, language can be built into every conditional photograph request 100 requiring that both parties submit to binding arbitration of all disputes helping to avoid more costly and time consuming legal battles in a court of law.

Second, the intermediary host acting through the central controller 200 can support the arbitration process by acting as first or final level arbiter for any dispute. In an arbitration the photograph seeker may submit the photographer's response to the central controller 200 along with the tracking number of the conditional photograph request 100, allowing the arbiter to establish whether or not the photographer fulfilled the conditions of the conditional photograph request 100. The photographer may also be requested to produce evidence that he/she met the conditions of the conditional photograph request.

In an alternative embodiment, transaction data can be sent to third party arbitrators outside the system. Central controller 200 may send all of the arbiters.

What is claimed:

1. A method for using a computer to facilitate the exchange of photographs between a photograph seeker and at least one of a plurality of possible photographers, comprising:
inputting into the computer a photograph request;
inputting into the computer a description of an incentive offered to the photographer to provide a picture in response to the photograph request;
inputting into the computer one or more of a plurality of express conditions that a photographer must meet to qualify for the incentive offered by the photograph seeker;
outputting the photograph request to a plurality of possible photographers;
inputting into the computer a file containing the requested photograph;
transfer of the offered incentive to the photographer.

2. The method of claim 1 wherein inputting into the computer a photograph request and the description of an incentive includes a simultaneous transfer of the incentive to an intermediary host/central controller.

3. The method of claim 1 wherein said incentive offered to the photographer consists of a specified amount of money.

4. The method of claim 1 in which the step of inputting into the computer a computer file containing a photograph responsive to the photograph seeker's request:
inputting into the computer a computer file containing a photograph from at least one photographer from a set of possible photographers, the set of photographers comprising at least one photographer, each computer file being responsive to the photograph seeker's photograph request and further comprising:
selecting one received photograph submission, thereby determining one selected photographer of the set of photographers;

5. The method of claim 1 in which the step of selecting one received photograph comprises: determining a first received photograph submission from a set of received photograph submissions thereby determining a first photographer from a set of photographers and in which the step of transferring the incentive offered comprises a transfer of the incentive offered to the first responding photographer.

6. The method of claim 1 in which the step of transferring the incentive to the photographer comprises the evaluation of any objection lodged by the photograph seeker with respect to the photograph submission from the photographer, and if no objections are lodged within a certain period of time, transfer of the incentive to the responding photographer.

7. The method of claim 1, further comprising; determining an active period during which the conditional photograph request is active; and in which the step of inputting into the computer a response to the photograph request is performed during the active period.

8. The method of claim 1, further comprising, inputting into the computer a designation that the conditional photograph request is “pending” or “completed” after the step of inputting into the computer a response to the photograph request thereby revoking the conditional offer to enter into a unilateral contract.
